(19) United States
(12) Patent Application Publication
(10) Pub. No.: US 2005/0080677 A1
(43) Pub. Date: Apr. 14, 2005

(54) Real-time entry and verification of PIN at point-of-sale terminal

(76) Inventor: Sheldon H. Foss JR., Suwanee, GA (US)

Correspondence Address: LAVA GROUP LAW BY SMITH & FROHWEIN, LLC, P.O. BOX 88148, ATLANTA, GA, 30356, US

(21) Appl. No.: 10/889,789

(22) Filed: Jul. 13, 2004

Related U.S. Application Data
(63) Continuation-in-part of application No. 10/685,277, filed on Oct. 14, 2003.

(51) Int. Cl. G06F 17/60

(52) U.S. Cl. 705/16; 705/64

(57) ABSTRACT

For financial transactions requiring PIN verification, the customer can now select his or her own number at the time of applying for the financial transaction instrument or account. The customer enters the PIN which is then encrypted using a transaction unique encryption scheme. The customer then re-enters the PIN which is once again encrypted using a transaction unique encryption scheme. As a result, two blocks of data are created for the same PIN, yet the encrypted values of the blocks are different. These blocks are provided to a central security system which can reverse the encryption process to a point at which it can generate an offset based on the received blocks. If the PINs were identically entered, the offsets will be equal, otherwise the offsets will not be equal. Thus, this technique allows a customer to select and enter his or her own PIN code, and have the PIN code entry verified by the system without the system actually knowing the value of the PIN code.

### CROSS-REFERENCE TO RELATED APPLICATIONS

The present invention is related to and incorporates by reference the following applications for United States Patents:

System for Providing a Checkless Checking Account filed on Aug. 22, 2003 and assigned Ser. No. 10/645,949; and

System and Method for Dynamically Managing a Financial Account filed on Aug. 22, 2003 and assigned Ser. No. 10/646,150.

The present application in a continuation in part of U.S. patent application Ser. No. 10/685,277 filed on Oct. 12, 2003.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to the field of financial services and, more particularly, to entry, establishment and verification of personal identification numbers PINs to be used in PIN based financial transactions.

It was not too far in the distance past that the concept of a credit card did not exist.

Depending on whom you ask, you may get a different story but, it appears that credit cards first came on the scene around 1951. This was the year that Diners Club issued their first credit card to 200 customers giving them instant credit access at 27 restaurants in New York. This was also the year that Franklin National Bank in New York issued the “Charge It” card which allowed customers to make charges at local retail establishments.

Today we live in an instant world that delivers to us MINUTE RICE, instant grits in a box, and the microwave oven. Life is just too short and too busy for us to be able to wait if it is not necessary. Thus, our entrepreneurs are constantly out there, looking for the next invention that can help reduce wait time for the consumer.

What do credit cards and instant grits have to do with each other? Well, obtaining credit is one of those areas that entrepreneurs have focused on in an effort to make credit more available, convenient and instant for consumers. Traditionally, for a consumer to obtain a credit card, the consumer was required to complete a credit application and mail the application to the credit card company. The credit card company would then process the application, verify the credit worthiness of the applicant, and then issue a card to the applicant with a particular credit limit. The card was then mailed to the applicant and once the card was received, the applicant could begin using the credit card. This process obviously resulted in days and even weeks of waiting.

Today, thanks to forward thinking companies such as COMPUCREDIT, we live in a world that now provides “instant credit”. A consumer can actually fill out an on-line application for credit using the Internet and obtain instant approval, complete a paper or electronic application in a retail store and have instant access to that credit for shopping. At the approval of the credit application, the consumer receives an account number or a voucher that can immediately be used within the retail store. This is a great benefit for both the consumer and the retail business. However, the introduction of new technologies and processes is usually greeted by the creation of additional, often times unforeseen problems. The introduction of instant credit has not been immune to such problems.

One of the biggest problems that have been experienced with the availability of instant credit is an increase in fraud and theft. There are many issues related to credit and credit card fraud and theft. One of these issues includes the use of lost or stolen credit cards. The use of a personal identifications number (PIN) is one technique that has been employed to deter fraudulent use of lost or stolen credit cards. A PIN number is assigned to a particular credit card account and to use the credit card, the consumer must provide or enter the PIN number.

With the introduction of instant credit, the protection that was available through the use of a PIN for traditional credit cards was simply not feasible. For a PIN system to be “consumer friendly” it is necessary to allow the consumer to select the digits or letters that make up the PIN. If a PIN is generated by a computer, the consumer is more likely to forget the actual PIN. Thus, there is a need in the art for a system to provide instant credit to a consumer while at the same time, allowing the consumer to have the security benefits available through the use of a PIN. There is also a need in the art for such a system to allow the consumer to select his or her own PIN and have the immediate protection of the PIN upon the approval of the credit.

Because a PIN is basically the key to a person's financial door, the creation, distribution, storage and handling of a PIN must be performed with the utmost security. In providing an instant credit solution in which a consumer can select a PIN in real-time, a great level of confidence must be instilled into the consumer and that confidence needs to be backed-up with state of the art security procedures. Thus, there is a need in the art for a system that provides instant credit and user selectable PINs to be constructed in a manner to ensure privacy and security for the PINs.

### BRIEF SUMMARY OF THE INVENTION

The present invention provides a solution to the deficiencies in the current art by providing a technique that allows a customer to select a personal identification number (PIN) in real-time along with applying for a credit card or a credit account. The credit card or account is immediately issued to the customer and the selected PIN is automatically and instantly active for use of the credit card.

More specifically, the present invention allows a consumer applying for credit to enter a PIN to be associated with the credit account. The PIN number is encrypted and provided to a central security system that operates to generate an offset based on the encrypted PIN number. The customer is then requested or required to enter the PIN a second time. The second entry of the PIN is again encrypted, however, the results of the encryption is a different value. This new value is a gain provided to the central security system that operates to generate another offset based on the encrypted PIN entered the second time. The encryption algorithm is such that the central security system will generate identical offsets if identical PIN values were entered. This is accomplished through a multi-tiered encryption scheme in which each entry of the PIN is encrypted using a shared key, and then encrypted again to generate a transaction-based unique value. Thus, subsequent entries of the same PIN will produce unique results thereby increasing the security of the PIN. The central security system that includes a shared key with the PIN encryption system operates to remove one level of the encryption and to generate an offset value. The central security system cannot fully decrypt the received information to recreate the PIN. However, the offsets are generated in a manner that will cause their value to be equal if the PIN value was equal. Thus, the present invention operates to allow a user to select and enter a PIN, and then provides a technique to ensure that the PIN was entered correctly.

### BRIEF DESCRIPTION OF THE DRAWINGS

FIG. 1 is a block diagram illustrating an environment in which the present invention can be implemented.

FIG. 2 is a flowchart diagram illustrating the process of the present invention when operating in the environment illustrated in FIG. 1.

### DETAILED DESCRIPTION

The present invention provides a system and method for a consumer, who is obtaining instant credit at a point-of-sale terminal, to select his or her own personalized PIN at the point-of-sale, and if approved for the credit, have instant credit that is protected by the selected PIN. In general, the present invention allows a consumer applying for credit to enter a PIN to be associated with the credit account. The PIN number is encrypted and provided to a central security system that operates to generate an offset based on the encrypted PIN number. The customer is then requested or required to enter the PIN a second time. The second entry of the PIN is again encrypted, however, the results of the encryption is a different value. This new value is a gain provided to the central security system that operates to generate another offset based on the encrypted PIN entered the second time. The encryption algorithm is such that the central security system will generate identical offsets if identical PIN values were entered. This is accomplished through a multi-tiered encryption scheme in which each entry of the PIN is encrypted using a shared key, and then encrypted again to generate a transaction-based unique value. Thus, subsequent entries of the same PIN will produce unique results thereby increasing the security of the PIN. The central security system that includes a shared key with the PIN encryption system operates to remove one level of the encryption and to generate an offset value. The central security system cannot fully decrypt the received information to recreate the PIN. However, the offsets are generated in a manner that will cause their value to be equal if the PIN value was equal. Thus, the present invention operates to allow a user to select and enter a PIN, and then provides a technique to ensure that the PIN was entered correctly.

Turning now to the figures in which like numbers refer to like elements, the present invention is described in greater detail.

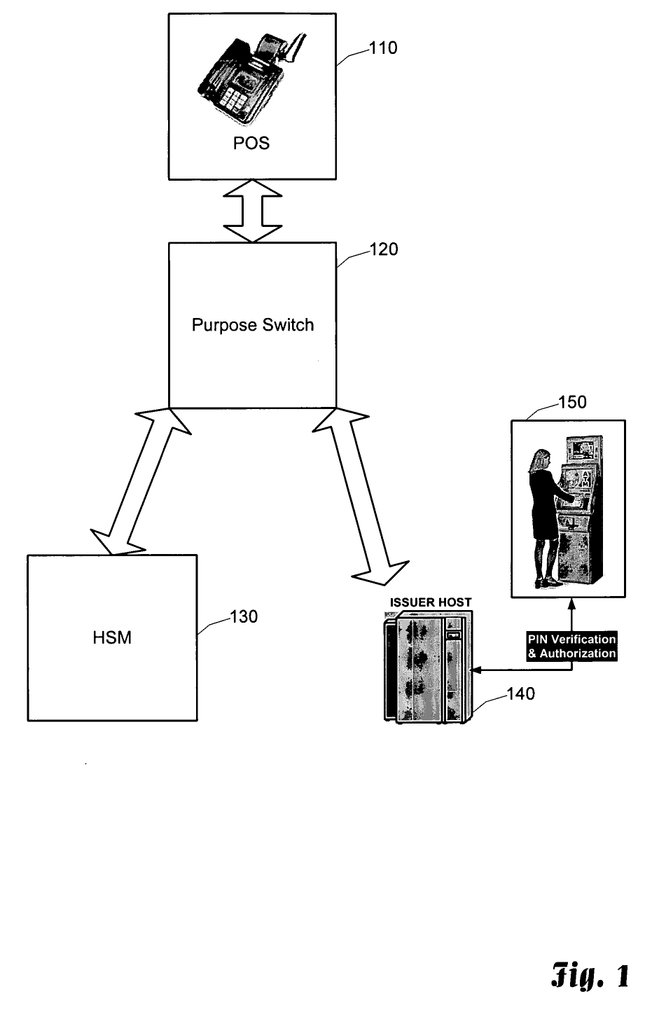

FIG. 1 is a block diagram illustrating an environment in which the present invention can be implemented. More details regarding such an environment are provided in the applications incorporated by reference. In general, the present invention can be embodied in a system that includes a point-of-sale terminal (POS) 110 that is connected to a financial service oriented switch. The assignee of the present invention calls this financial service oriented switch the Purpose Switch 120. In general, the Purpose Switch 120 is used in the provision of a variety of financial services including credit approvals, transaction approvals and closings, credit card issuance, stored-value-card issuance and debiting, or the like. In an environment suitable for the present invention, such a switch, in providing financial services, will allow a customer of the financial service to enter in real-time, a PIN. In addition, the switch will verify the correctness of the PIN by requiring the customer to re-enter the PIN. The Purpose Switch 120 provides this capability in cooperation with the Host Security Module (HSM) 130.

The HSM 130 houses the guts of an encryption scheme. In different embodiments, various encryption schemes can be used. The present invention is being described as operating in conjunction with an HSM provided by Atalla. The HSM holds the master keys that are used to generate the various keys used in implementing the encryption process. One such key is the Base Derivation Key (BDK). This key resides in the HSM 130 and is also injected or loaded into the POS 110. Those skilled in the art will be familiar with secure techniques to generate and transfer such keys into devices. The keys are established in such a manner that allows the POS 110 to encrypt a plaintext PIN but, the POS 110 cannot decrypt the results, nor can the HSM 130. Rather, the HSM 130 can apply its encryption algorithm in a manner to generate an offset from the encryption results of the POS 110. This offset is identical for any input from the POS 110 as long as the account number and the PIN number entered by the customer are the same. Thus, the POS 110 can encrypt a PIN, send it to the HSM 130 which then generates an offset. If the POS 110 encrypts the same PIN, the results of the encryption will be different; however, the HSM 130 can generate the same offset from those results. Thus, the HSM 130 never actually sees the plaintext version of the PIN.

The HSM 130 also shares a key or keys with the Issuer Host 140. In a financial services setting in which PINs are used for authenticating customers, the Issuer Host 140 performs a PIN verification process. Similar to the process performed in a POS 110 device where once a customer enters a PIN it is encrypted before being sent to the next component in the system, when a customer enters a PIN at an ATM or other similar device (such as a point-of-sale terminal), it is encrypted before being sent to the Issuer Host 140. Through sharing keys between the HSM 130 and the Issuer Host 140, a customer can enter a PIN at an ATM machine 150 and the Issuer Host 140, without knowing the PIN, can verify that the entered PIN matches the PIN originally programmed and accepted by the HSM 130. These techniques are well known to those skilled in the art that will be familiar with PIN verification processes and procedures.

Although in conjunction with FIG. 1, the environment has been described as including distinct systems, it will be appreciated that the present invention can also operate in an environment in which the various components or functions provided by the components reside in a different number of systems. For instance, the Purpose Switch 120 and the HSM 130 could be combined into a single system or platform, or features of the Purpose Switch 120 could be incorporated into the HSM 130 or visa versa.

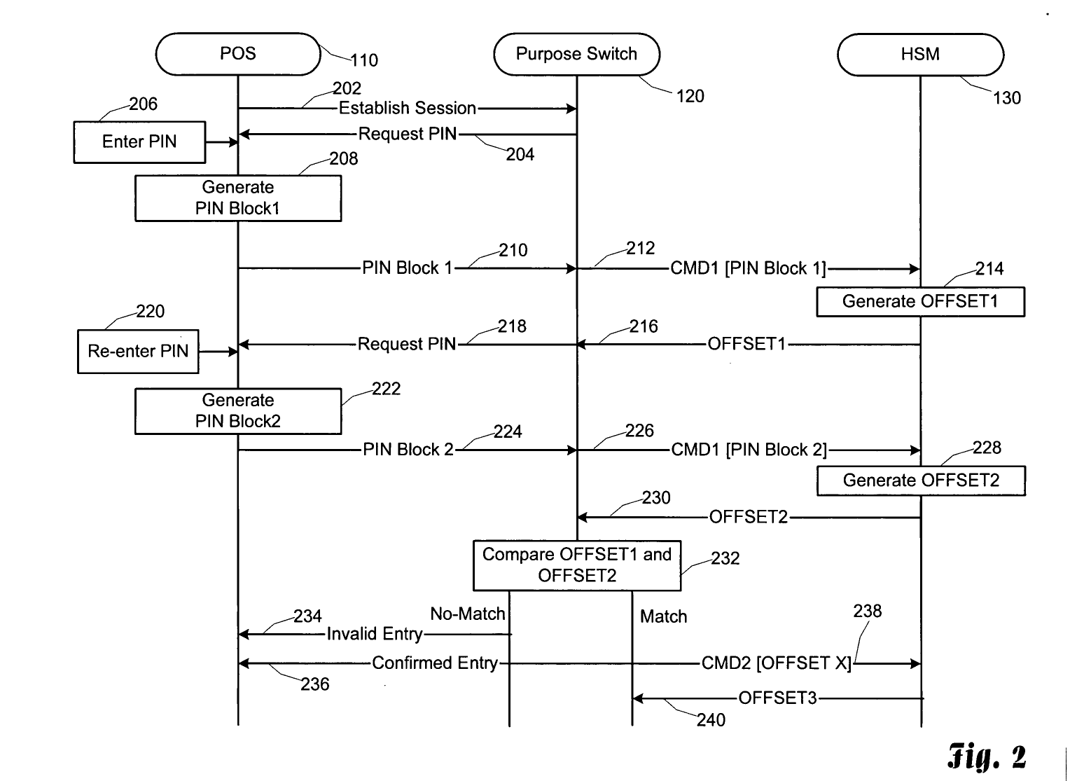

FIG. 2 is a flowchart diagram illustrating the process of the present invention when operating in the environment illustrated in FIG. 1. Initially a customer or merchant initiates a session using the POS 110. The session could be a variety of different session types but in general, involves the initial establishment of a PIN. For instance, the customer could be requesting a credit approval, initializing a stored-value card or simply changing the PIN for a previously issued card. Obviously several other situations could be contemplated in which the present invention can apply and the particular situation is not limiting on the operation of the present invention. In response to initiating the session, the POS 110 and Purpose Switch 120 exchange pertinent information and establish a session 202. At some point of time during the session, the Purpose Switch 120 determines that a PIN should be established. This determination can include a request from the POS 110 or may be initiated by the Purpose Switch 120. In either case, the Purpose Switch 120 sends a request 204 to the POS 110 for the entry of the PIN. In response to the request 204, the customer enters a PIN 206 using the POS 110.

The POS 110, in response to receiving the PIN, performs an encryption process to generate PIN Block1 208. The encryption process can vary depending on the particular encryption technology employed and the present invention is not limited to any particular encryption technology. However, in an exemplary embodiment, a three level DES approach is used as is common in the industry. In general, this encryption technology employs the use of a based derivative key BDK that is located within the HSM 130 and the POS 110. The keys themselves are generated from a common key scheme and either the BDK or variants thereof are the keys stored in the POS 110 and the HSM 130. Further, the generation process involves churning the employed encryption algorithm with the PIN, an account number associated with the customer and the BDK or its variant and then applying a Derived Unique Key Per Transaction DUKPT to create PIN Block1.

Upon generating the PIN Block1, the POS 110 provides the PIN Block1 to the Purpose Switch 120 210. The Purpose Switch 120, upon receiving the PIN Block1, provides it to the HSM 130 along with a command to generate an offset 212. This process is based on design standards established by the manufacturer of the particular encryption system embodied within the HSM 130. In an exemplary embodiment, the HSM 130 is provided by Atalla and the command to generate the offset is known in the industry as command 31.

The HSM 130, upon receiving the command 212 operates to generate OFFSET1 214. The HSM 130 then provides the generated OFFSET1 to the Purpose Switch 120 216. The Purpose Switch 120 stores the OFFSET1 in its internal memory and then proceeds to send a request to the POS 110 to instruct the customer to re-enter the PIN 218.

The customer, when prompted by the POS 110, re-enters the same PIN that was previously entered 220. Similar to the response when receiving the first entered PIN, the POS 110 generates PIN Block2 222. PIN Block2 will not have the same value as PIN Block1 even though they were generated using the same keys. This is due to the application of the DUKPT process. The POS 110 then provides PIN Block2 to the Purpose Switch 120 224.

Upon receiving PIN Block2, the Purpose Switch 120 again invokes the service of the HSM 130 to generate an offset using PIN Block2 226. The HSM 130 will similarly process PIN Block2 to generate OFFSET2 228. The HSM 130 then provides OFFSET2 to the Purpose Switch 120 230.

The Purpose Switch 120 then operates to compare the values of OFFSET1 and OFFSET2 232. As previously mentioned, the present invention is not tied or dependent upon any particular encryption technology. However, the present invention is based on the fact that the plaintext PIN is never transmitted or stored anywhere in the system. Rather, only encrypted versions of the PIN are transmitted and stored. In the currently described system, the encryption process effectively performs a double encryption. The first level is using the BDK and the second level is the application of the DUKPT. When the PIN Blocks arrive at the HSM 130, the HSM 130 is able to effectively reverse the uniqueness provided by the DUKPT process and generate an OFFSET that is based on the PIN, the BDK, the account number and other common elements used to generate the PIN Block. Thus, the HSM can generate matching offsets for the unique PIN Blocks. These offsets are provided to the Purpose Switch 120 for comparison.

The Purpose Switch 120, after receiving OFFSET1 and OFFSET2 compares them to determine if they match 232. If OFFSET1 and OFFSET2 do not match, then the PINs entered by the customer were not matching. If the offsets do not match, the Purpose Switch 120 can conduct an error recovery process, such as sending an error message 234 to the POS 110 indicating that the PINs did not match and need to be re-entered. Depending on the particular implementation, the session can be terminated and required to be re-established, the POS 110 can request the customer to re-enter the PIN, or other error recovery processing can be performed and the present invention is not limited to any particular process.

If the Purpose Switch 120 determines that the offsets match, the Purpose Switch 120 can provide a confirmation to the POS 110 that the PIN has been successfully entered 236—although this is not a requirement for the present invention. In addition, the Purpose Switch 120 may then invokes a command of the HSM 130 to convert the offset into a format that is compatible with the Issuer Host 140. It should be noted that if the Issuer Host 140 is compatible with the current format of the offset, the OFFSET1 or OFFSET2 (OFFSETx) could be directly provided to the Issuer Host 140 or, could be further encrypted and then provided to the Issuer Host 140. In an exemplary embodiment, the OFFSETx is in an ANSI format and needs to be converted to IBM 3624 format. This task is accomplished by invoking the appropriate command in the HSM 130 and providing OFFSETx along with the command 238.

In response to receiving the conversion command 238, the HSM 130 operates to generate OFFSET3 and provides it to the Purpose Switch 120 240. The Purpose Switch 120 can then provide the OFFSET 3 to the Issuer Host 140 to be used for future PIN verification. As previously described, the HSM 130 and the Issuer Host 140 operate under shared keys. When the Issuer Host 140 receives a PIN Block from the ATM machine 150, the Issuer Host is able to generate an offset using the PIN Block and that offset will match the OFFSET3 if the correct PIN for the given account number is entered. Those skilled in the art will be familiar with the technology employed for performing PIN verification and the present invention does not require any modifications or enhancements to such a procedure but rather, operates in conjunction with such standards.

Thus, the present invention provides a novel technique for allowing a customer to establish a PIN at a point-of-sale and to verify the entry of the PIN. Furthermore, the plaintext version of the PIN is never transmitted or stored anywhere within the system and thus, the PIN is secure.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for allowing a customer to select a PIN in real-time at a point-of- sale terminal, the method comprising the steps of:
receiving a first entry of a PIN at the point-of-sale terminal;
encrypting the PIN to generate a first unique value;
receiving a second entry of the PIN at the point-of-sale terminal;
encrypting the PIN to generate a second unique value;
providing the first and second unique values to a central security system;
generating a first offset based on the first unique value and a second offset based on the second unique value at the central security system, the offsets being generated in a manner that does not determine the actual value of the PIN; and
if the first offset is equal to the second offset, providing confirmation to the point-of-sale terminal that the PIN values have been entered correctly.

2. The method of claim 1, wherein in response to determining that the first offset is equal to the second offset, further comprising the steps of:
creating a third offset based on one of the first or second offsets, the third offset being in a format compatible with a host system;
providing the third offset to the host system.

3. The method of claim 2, wherein the host system operates in cooperation with a customer access system, further comprising the steps of:
receiving a third entry of the PIN, the third entry of the PIN being received at the customer access system;
encrypting the third entry of the PIN to create a third unique value;
providing the third unique value to the host system;
generating a fourth offset value based on the third unique value at the host system; and
if the fourth offset value is equal to the third offset value, determining that the PIN was entered correctly and granting access to a financial transaction.

4. The method of claim 3, wherein the customer access system is an automatic teller machine and the step of granting access to a financial transaction comprises the step of providing access to the customer's account.

5. The method of claim 3, wherein the customer access system is a point-of- sale terminal and the step of granting access to a financial transaction comprises the step of approving the customer for a purchase.

6. The method of claim 1, wherein if the first offset does not equal the second offset, further comprising the step of providing an error message to the point-of-sale terminal.

7. A system that enables a customer applying for approval for a credit account to enter a real-time enabled and verified customer-selected PIN value to be used for subsequent financial transaction utilizing the approved credit account, the system comprising the components of:
a point-of-sale terminal having a customer interface;
a financial services switch that is communicatively coupled to the point-of-sale terminal;
a central security system that is communicatively coupled to the financial services switch;
the point-of-sale terminal being operable to:
receive a first entry of a PIN and to encrypt the first entry of the PIN to generate a first unique value;
receive a second entry of the PIN and to encrypt the PIN to generate a second unique value; and
provide the first and second unique values to the financial services switch;
the financial services switch being operable to:
receive the first and second unique values;
provide the first and second unique values to the central security system;
receive from the central security system a first and second offset corresponding to the first and second unique values; and
if the first and second offset values do not match, providing a error indicator to the point-of-sale terminal; and
the central security system being operable to:
receive the first and second unique values;
generate the first and second offset values, the offset values being generated in such a manner that if the first entry of the PIN and the second entry of the PIN were identical, the offsets will be identical, yet without being able to generate the actual values of the first and second entries of the PIN; and
providing the first and second offset to the financial services switch.

8. The system of claim 7, wherein in the financial services switch is further operable to provide a confirmation message to the point-of-sale terminal if the first and second offset match.

9. The system of claim 8, further comprising an interface to a host system that is operable to perform PIN verification operations in conjunction with industry standard techniques,
the financial services switch being Her operable to:
provide one of the first or second offsets to the central security system along with a transformation request; and
in response, receive a third offset from the central security system; and
the central security system being further operable to:
in response to receiving the first or second offsets along with the transformation request, generating a third offset based on one of the first or second offsets, the third offset being in a format compatible with a host system and that provides a reference for the host system to verify that subsequent entries of the PIN are correct.

10. A method for allowing a customer to select a PIN in real-time at a point-of- sale terminal, the method comprising the steps of:
receiving a first entry of a PIN at the point-of-sale terminal;
encrypting the first entry of the PIN to generate a first unique value;
receiving a second entry of the PIN at the point-of-sale terminal;
encrypting the second entry of the PIN to generate a second unique value;
providing the first and second unique values to a central security system;
generating a first offset based on the first unique value and a second offset based on the second unique value at the central security system, the offsets being generated in a manner that does not determine the actual value of the PIN; and
if the first offset is equal to the second offset:
providing confirmation to the point-of-sale terminal that the PIN values have been entered correctly;
creating a third offset based on one of the first or second offsets, the third offset being in a format compatible with a host system;
providing the third offset to the host system.

11. The method of claim 10, wherein the host system operates in cooperation with a customer access system, further comprising the steps of:
receiving a third entry of the PIN, the third entry of the PIN being received at the customer access system;
encrypting the third entry of the PIN to create a third unique value;
providing the third unique value to the host system;
generating a fourth offset value based on the third unique value at the host system; and
if the fourth offset value is equal to the fourth offset value, determining that the PIN was entered correctly and granting access to a financial transaction.

12. The method of claim 11, wherein the customer access system is an automatic teller machine and the step of granting access to a financial transaction comprises the step of providing access to the customer's account.

13. The method of claim 11, wherein the customer access system is a point-of-sale terminal and the step of granting access to a financial transaction comprises the step of approving the customer for a purchase.

14. The method of claim 11, wherein the steps of encrypting the first entry of the PIN to generate a first unique value and encrypting the second entry of the PIN to generate a second unique value are performed using a derived unique key per transaction encryption scheme.

15. The method of claim 14, wherein prior to applying the derived unique key per transaction encryption scheme, the first and second entry of the PIN are encrypted using a base derivation key that is shared with the central security system.

16. The method of claim 10, wherein if the first offset does not equal the second offset, further comprising the step of providing an error message to the point-of-sale terminal.

17. The method of claim 10, wherein the steps of encrypting the first entry of the PIN to generate a first unique value and encrypting the second entry of the PIN to generate a second unique value are performed using a derived unique key per transaction encryption scheme.

18. The method of claim 17, wherein prior to applying the derived unique key per transaction encryption scheme, the first and second entry of the PIN are encrypted using a base derivation key that is shared with the central security system.

19. The method of claim 1, wherein the PIN replaces an existing PIN.

20. The system of claim 7, wherein the PIN replaces an existing PIN.

21. The method of claim 10, wherein the PIN replaces an existing PIN.
